(19) United States
(12) Patent Application Publication
(10) Pub. No.: US 2012/0133660 A1
(43) Pub. Date: May 31, 2012

(54) DATA PROCESSING METHOD AND APPARATUS IN HETEROGENEOUS MULTI-CORE ENVIRONMENT

(75) Inventors: Gyeong Ja JANG, Yongin-si (KR); Choong Hun Lee, Yongin-si (KR); Seok Yoon Jung, Seoul (KR); Shi Hwa Lee, Seoul (KR)

(73) Assignee: SAMSUNG ELECTRONICS CO., LTD., Suwon-si (KR)

(21) Appl. No.: 13/308,007

(22) Filed: Nov. 30, 2011

(30) Foreign Application Priority Data
Nov. 30, 2010 (KR) 10-2010-0120375

(51) Int. Cl. G06F 15/167

(52) U.S. Cl. 345/541

(57) ABSTRACT

A method and apparatus for processing data in a heterogeneous multi-core environment, capable of reducing data processing time by storing frames not having redundant data only among input frames in a shared memory. The apparatus compares a second frame with a first frame having a time difference with respect to a first frame, thereby determining identity between the first frame and the second frame. The apparatus stores address information related to the first frame or stores the second frame according to the determination result, thereby reducing quantity of data to be updated.

### CROSS-REFERENCE TO RELATED APPLICATIONS

This application claims the priority benefit of Korean Patent Application No. 10-2010-0120375, filed on Nov. 30, 2010, in the Korean Intellectual Property Office, the disclosure of which is incorporated herein by reference.

### BACKGROUND

1. Field

Example embodiments of the following description relate to a method and apparatus for reducing time for processing rendering data, and more particularly, to a method and apparatus to determine whether a second frame and a first frame having a time difference are identical, and storing frames not having redundant data based on the determination.

2. Description of the Related Art

Rendering refers to a final process of a graphics pipeline that provides reality to a 2-dimensional (2D) image when producing the 2D image from 3D descriptions of a computer graphics scene, such as, a geometric model, a motion, a camera, a texture, lighting information, and the like. Therefore, performance of the graphic pipeline is highly dependent on types of the rendering. Also, the types of the rendering determine reality and quality of an output image. The rendering technology has been greatly developed compared to the past so that even an extremely realistic image is achieved. However, a lot of calculation time is required for the extremely realistic image.

According to a conventional rendering technology, when a scene is changed, the total graphic data of the changed scene is rendered. However, most scenes frequently have partial changes. Therefore, if the total graphic data is rendered every time the scene is changed, operations from rendering to displaying are repeated, accordingly requiring much time and a large memory space.

### SUMMARY

The foregoing and/or other aspects are achieved by providing a data processing apparatus including an interface unit to be inputted with a second frame; a processing unit to compare the second frame with a first frame having a time difference from the second frame, and thereby determining whether the first frame and the second frame are identical; and a shared memory to store address information related to the first frame when the first frame and the second frame are identical and to store the second frame when the first frame and the second frame are not identical.

The first frame and the second frame may each include context data. The processing unit may store, in the shared memory, address information related to first context data contained in the first frame, when the first context data and second context data contained in the second frame are identical, and may store the second context data in the shared memory when the first context data contained in the first frame and the second context data contained in the second frame are not identical.

The first context data and the second context data may each include at least one of attribute data, texture data, and a render state, and when the processing unit determines that part of the second context data is identical to the first context data, the shared memory may store at least one of second attribute data, second texture data, and a second render state, which is different from the first context data, and stores address information related to at least one of first attribute data, first texture data, and a first render state, which is identical to the second context data.

The data processing apparatus may further include a rendering unit to generate first rendering data, using the first frame stored in the shared memory, and to generate second rendering data using the address information related to the first frame or using the second frame.

The first frame and the second frame may each include shader context data. The processing unit may store, in the shared memory, address information related to a first shader context data contained in the first frame, when the first shader context data and a second shader context data contained in the second frame are identical, and may store the second shader context data in the shared memory, when the first shader context data contained in the first frame and the second shader context data contained in the second frame are not identical.

The foregoing and/or other aspects are achieved by providing a data processing apparatus including an interface unit to be input with a first object in a frame; a processing unit to compare the first object with a second object having an object identification ID different from the first object, and thereby determining whether the first object and the second object are identical; and a shared memory to store address information related to the first object when the first object and the second object are identical and to store the second object when the first object and the second object are not identical, wherein objects having different object IDs are treated at a different time or at a same time.

The foregoing and/or other aspects are achieved by providing a data processing method including being input with a second frame; determining whether the second frame is identical to a first frame having a time difference from the second frame; and storing address information related to the first frame or storing the second frame in a shared memory according to the determination result.

The data processing method may further include the first frame and the second frame, which include shader context data, and the storing of the address information or the second frame includes: storing, in the shared memory, address information related to first shader context data included in the first frame when the first shader context data and second shader context data included in the second frame are identical; or storing, in the shared memory, the second shader context data in the shared memory when the first shader context data included in the first frame and the second shader context data contained in the second frame are not identical.

The foregoing and/or other aspects are also achieved by providing a data processing method including determining whether a first object contained in a frame is identical to a second object having an object ID different from the first object, by comparing the first object with the second object; and storing address information related to the first object or storing the second object in a shared memory according to the determination result.

The foregoing and/or other aspects are also achieved by providing a system to process data, including an interface unit to receive a first frame and a second frame, wherein the first frame and the second frame are temporally different; a processing unit to compare the first frame with the second frame to determine whether the first frame and the second frame are identical; and a shared memory to store address information related to the first frame when the first frame and the second frame are identical and to store the second frame when the first frame and the second frame are not identical.

Additional aspects, features, and/or advantages of example embodiments will be set forth in part in the description which follows and, in part, will be apparent from the description, or may be learned by practice of the disclosure.

### BRIEF DESCRIPTION OF THE DRAWINGS

These and/or other aspects and advantages will become apparent and more readily appreciated from the following description of the example embodiments, taken in conjunction with the accompanying drawings of which:

FIG. 1 illustrates a block diagram of a data processing apparatus according to example embodiments;

FIG. 2 illustrates a flowchart showing a data processing method according to example embodiments;

FIG. 3 illustrates a diagram showing construction of rendering data according to example embodiments;

FIG. 4 illustrates a diagram showing a frame stored in a shared memory according to example embodiments;

FIG. 5 illustrates a diagram showing a procedure of processing context data according to example embodiments;

FIG. 6 illustrates a diagram showing reduction of data processing time according to example embodiments;

FIG. 7 illustrates a diagram showing the reduction of data processing time according to other example embodiments;

FIG. 8 illustrates a diagram showing a structure of data related to context data according to example embodiment;

FIG. 9 illustrates a diagram showing a structure of data related to shader context data according to example embodiments; and

FIG. 10 illustrates a flowchart showing a data processing method according to other example embodiments.

### DETAILED DESCRIPTION

A 3-dimensional (3D) application may be expressed by a plurality of 3D objects and various shader effects applied to the 3D objects, or expressed by an animation of the 3D objects. Each of the 3D objects is constituted by geometric primitives and expressed by a vertex stream having various attributes such as vertices, colors, normals, and texture coordinates. In general, the 3D application is generated using an open graphic library embedded system (OPENGL|ES) application program interface (API) program. The program is analyzed and processed by a rendering engine. Here, the vertex stream of the 3D object is processed in units of glDraw* commands.

Data to be rendered may include a context consisting of the vertex stream, a texture image, light, a render state, and the like, and a shader context that includes a shader program to realize shader effects (motion, color, shade effect, and the like) to be applied to the vertex stream and the light.

The rendering engine may manage and process the data to be rendered, in the form of the context or the shader context.

In this instance, information contained in the context and information contained in the shader context may be either identical or dissimilar with respect to every object of a certain frame. Also, the information of the context and the information of the shader context may be either identical or dissimilar with respect to every frame.

A game, as an example of the 3D application, includes an object for various shader effects and an animation of the object.

For real-time rendering of the 3D application, quick processing of the data to be rendered is required. That is, transmission and updating of the data to be rendered need to be performed quickly.

For such quick processing of the 3D application, a multi-core processor including a central processing unit (CPU) and a graphics processing unit (GPU) is applied to a mobile device, such as a smart phone. The multi-core processor has a platform where the GPU processes data processed by the CPU, or the CPU processes data processed by the GPU. A method for increasing a data processing speed is necessitated to increase a processing speed of the 3D application in the multi-core platform.

Example embodiments suggested herein provide a method for quickly transmitting data processed by a certain core to another core, that is, the method for reducing the number of data transmissions, and the quantity of data transmitted. More specifically, data processed by a certain core, to be transmitted to another core, is stored in a shared memory. The other core takes and processes the data in the shared memory. Here, data access and update cost are generated between the two cores. In this case, previous data and current data are compared. When data values are unchanged, the previous data value is reused. When the data values are changed, only a changed value is updated or stored and change of the value is updated. Data that determines change of the data values may be managed in the form of the context and the shader context.

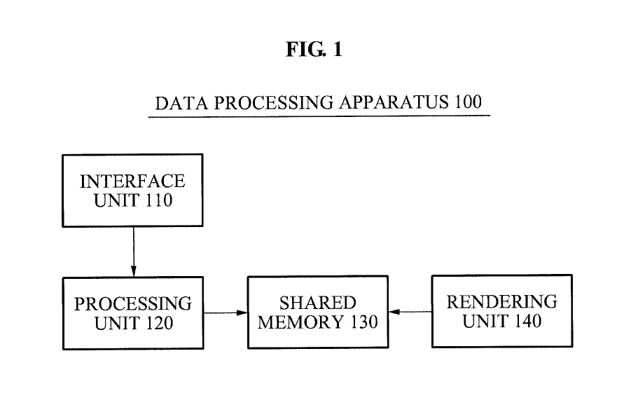

FIG. 1 illustrates a block diagram of a data processing apparatus 100 according to example embodiments.

Referring to FIG. 1, the data processing apparatus 100 includes an interface unit 110, a processing unit 120, a shared memory 130, and a rendering unit 140.

The interface unit 110 may be inputted with a first frame. The first frame may refer to a first-order frame constituting rendering data. When an OPENGL|ES is executed in an application that processes the rendering data, calling of a glDraw* command may be interpreted as input of the frame. For example, input of the first frame to the interface unit 110 may mean that the glDraw* command(n) is called. Here, n denotes a natural number representing an object ID (identification) variable.

The processing unit 120 may determine whether the shared memory 130 stores a frame temporally preceding the first frame. When the temporally preceding frame is not stored in the shared memory 130, the processing unit 120 may store the first frame in the shared memory 130.

The shared memory 130 stores the first frame. The first frame may contain context data, shader context data, and the like, which constitute the rendering data. That is, the shared memory 130 stores data related to the first frame.

The rendering unit 140 may extract the first frame from the shared memory 130, thereby generating first rendering data related to the first frame.

The interface unit 110 may be inputted with a second frame. The second frame may refer to a second-order frame having a time difference with respect to the first frame. In other words, the first frame may temporally precede the second frame. For example, input of the second frame to the interface unit 110 may mean that a glDraw* command(n+1) is called.

The processing unit 120 may determine whether the shared memory 130 stores the first frame temporally preceding the second frame. When the first frame is stored, the processing unit 120 may compare the first frame with the second frame. That is, the processing unit 120 may determine whether the first frame and the second frame are identical to each other. For example, the processing unit 120 may compare the same kind of data, such as the context data or the shader context data, of the first frame and the second frame to determine whether the data contained in the first frame and the data contained in the second frame are identical.

When the first frame and the second frame are identical to each other as a result of the determination, the shared memory 130 may store address information related to the first frame. Since the data related to the first frame is already stored in the shared memory 130, redundant storage of the same data is not necessary if the first frame and the second frame are identical. In this case, the shared memory 130 may store only the address information containing the data related to the first frame, instead of the second frame. In this case, when generating second rendering data related to the second frame, the rendering unit 140 may use the address information storing the first frame. In other words, the rendering unit 140 may generate the second rendering data using the first frame contained in the address information. For example, the rendering unit 140 may reuse the first rendering data that is already generated.

When the first frame and the second frame are not identical to each other, the shared memory 130 may store the second frame. Since data related to the second frame is not stored in the shared memory 130, the shared memory 130 may store the second frame necessary for generation of the second rendering data. In this case, the rendering unit 140 may use the second frame to generate the second rendering data related to the second frame.

Hereinafter, example embodiments to determine identity between the first frame and the second frame will be described.

When first context data contained in the first frame and second context data contained in the second frame are identical, the processing unit 120 may store address information related to the first context data in the shared memory 130. Therefore, the rendering unit 140 may generate the second rendering data related to the second frame using the first context data contained in the address information related to the first context data.

When the first context data and the second context data are not identical, the processing unit 120 may store the second context data in the shared memory 130. In this case, the rendering unit 140 may generate the second rendering data related to the second frame using the second context data.

Context data may include at least one of attribute data, texture data, and a render state. The attribute data may include vertices, colors, normals, texture coordinates, and the like.

The processing unit 120 may compare the first context data with the second context data and determine that part of the second context data is identical to the first context data. In this case, the shared memory 130 may store at least one of second attribute data, second texture data, and a second render state, which is not identical to the first context data. Also, the shared memory 130 may store address information related to at least one of first attribute data, first texture data, and a first render state, which is identical to the second context data.

For example, the first attribute data and the first texture data may be identical to the second attribute data and the second texture data, respectively, whereas the first render state is different from the second render state. In this case, the shared memory 130 may store address information of the first attribute data instead of the second attribute data, store address information of the first texture data instead of the second texture data, and store the second render state.

Depending on embodiments, the shader context data of the first frame and of the second frame may be compared to determine identity between the first frame and the second frame. For example, the shader context data may include a shader program, and a shader program variable, such as a uniform variable and a varying variable.

When first shader context data contained in the first frame and second shader context data contained in the second frame are identical to each other, the processing unit 120 may store address information related to the first shader context data in the shared memory 130. The rendering unit 140 may generate the second rendering data related to the second frame, using the first shader context data stored in the address information related to the first shader context data.

When the first shader context data and the second shader context data are not identical, the processing unit 120 may store the second shader context data in the shared memory 130. The rendering unit 140 may generate the second rendering data related to the second frame, using the second shader context data.

According to other example embodiments, when an object or a sub object is updated as a result of comparing objects or sub objects in one frame, the processing unit 120 may store data related to a current object in the shared memory 130. When the object or the sub object is not updated, the processing unit 120 may store only address information related to a previous object in the shared memory 130. In other words, whereas update is determined by comparing the frames in the previous example embodiments, according to the present example embodiments described hereinafter, a plurality of objects in a frame are compared to determine the update so that data is selectively stored in the shared memory 130.

More specifically, the interface unit 110 is input with an object contained in the frame. The object may refer to basic elements constituting an image, such as a person, a bridge, a building, a tree, and the like. A sub object may be a particular element of the object. For example, when the object is a person, the sub object may include a head, an arm, a leg, and the like of the person.

The processing unit 120 may compare the first object with a second object having an object ID difference with respect to the first object to determine whether the first object and the second object are identical to each other. Here, the first object and the second object are identical or different objects having a different input order with respect to the interface unit 110.

When the first object and the second object are determined to be identical, the shared memory 130 may store address information related to the first object. When the first object and the second object are determined to be not identical, the shared memory 130 may store the second object.

In addition, the processing unit 120 may compare a first sub object related to the first object with a second sub object having a sub-object ID difference with respect to the first sub object, to determine whether the first sub object and the second sub object are identical. The shared memory 130 may store address information related to the first sub object when the first sub object and the second sub object are identical, and may store the second sub object when the sub object and the second sub object are not identical.

In the same manner as the frames, the first object and the second object may each include context data. When first context data contained in the first object and second context data contained in the second object are identical to each other, the processing unit 120 may store address information related to the first context data in the shared memory 130. When the first context data and the second context data are not identical, the processing unit 120 may store the second sub object in the shared memory 130. This procedure has already been described in detail above.

The first context data and the second context data may each include at least one of attribute data, texture data, and a render state. When the processing unit 120 determines that part of the second context data is identical to the first context data, the shared memory 130 stores at least one of the second attribute data, the second texture data, and the second render state, which is not identical to the first context data. Additionally, the shared memory 130 may store the address information related to at least one of the first attribute data, the first texture data, and the first render state, which is identical to the second context data.

Alternatively, the first object and the second object may each include shader context data. When first shader context data contained in the first object and second shader context data contained in the second object are identical, the processing unit 120 may store address information related to the first shader context data in the shared memory 130. When the first shader context data and the second shader context data are not identical, the processing unit 120 may store the second shader context data in the shared memory 130.

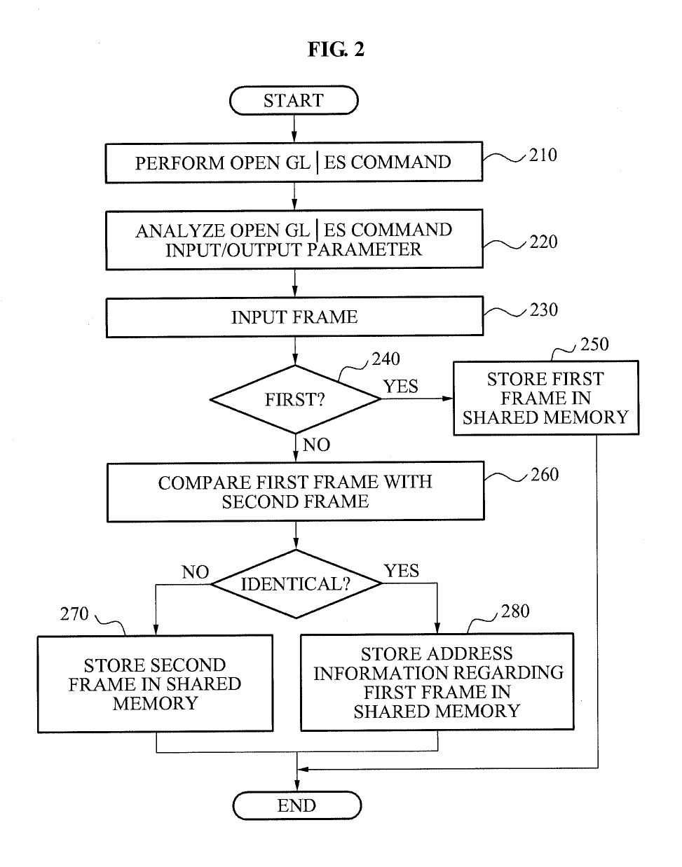

FIG. 2 illustrates a flowchart of a data processing method according to example embodiments.

Referring to FIG. 2, the data processing apparatus 100 may execute the OPENGL|ES in operation 210.

In operation 220, the data processing apparatus 100 may analyze an input and output parameter of the OPENGL|ES. The OPENGL|ES may include a plurality of commands for rendering, the commands such as glDraw*, glFlush, glColor, and the like.

In operation 230, the data processing apparatus 100 may be inputted with a frame. For example, the input of the frame may mean that the glDraw* command, out of the plurality of commands in the OPENGL|ES, is called.

In operation 240, the data processing apparatus 100 may determine whether the input frame is a first-order frame, that is, the first frame. When the input frame is the first frame, the data processing apparatus 100 may store the first frame in the shared memory 130 in operation 250. In other words, the data processing apparatus 100 may store data related to the glDraw* command(n) in the shared memory 130. In this case, it is interpreted that the first frame is input in operation 230.

When the input frame is not the first frame, the data processing apparatus 100 may compare the first frame (glDraw* command(n)) with the second frame (glDraw* command(n+1)) in operation 260, thereby determining whether the first frame and the second frame are identical. When comparing the first frame with the second frame, data of the same object are compared. That is, for example, a k-th object of the first frame is compared with a k-th object of the second frame. In this case, it is interpreted that the second frame is input in operation 230.

When the first frame and the second frame are not identical, the data processing apparatus 100 stores the second frame in the shared memory 130 in operation 270. That is, the data processing apparatus 100 may store data related to the glDraw* command(n+1) in the shared memory 130. In this case, the rendering unit 140 may generate the second rendering data related to the second frame using the second frame.

When the first frame and the second frame are identical, the data processing apparatus 100 may store the address information related to the first frame in the shared memory 130 in operation 280. That is, the data processing apparatus 100 may store the address information containing data related to the glDraw* command(n), in the shared memory 130. In this case, the rendering unit 140 may generate the second rendering data using the first frame contained in the address information.

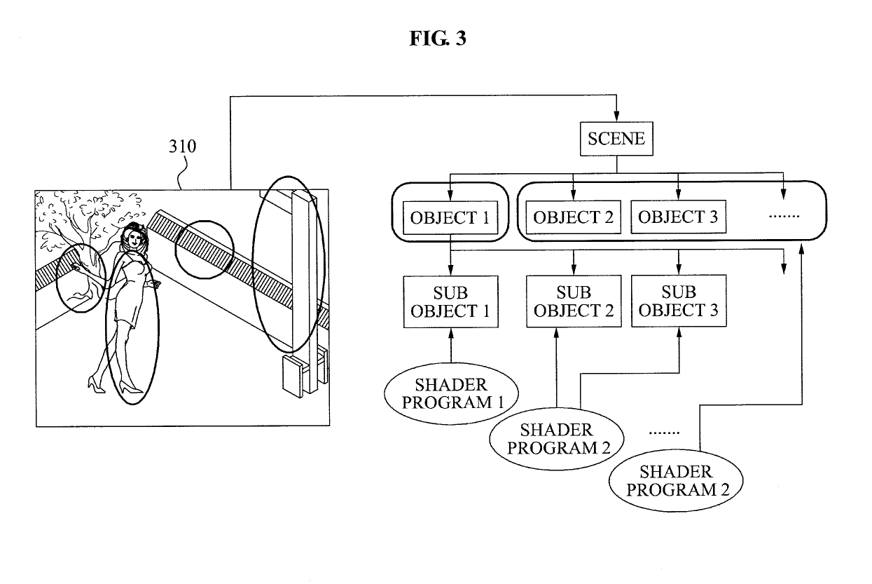

FIG. 3 illustrates a diagram showing construction of the rendering data according to example embodiments.

As shown in FIG. 3, a scene 310 includes a plurality of objects, for example, an object 1, an object 2, and an object 3. The data processing apparatus 100 may generate rendering data from the scene 310. For example, the rendering data may consist of units of geometric objects. Each of the geometric objects may consist of at least one sub object. The same or different shader programs may be applied to every geometric object of the object or the sub object.

Thus, the rendering data may be classified depending on whether the shader programs are either the same or dissimilar. For example, the shader program may be classified according to identifiers. The data processing apparatus 100 may classify rendering data having the same shader program identifier as the same data value.

For example, identity between frames may be determined by comparing vertex data values contained in the context data. For example, the data processing apparatus 100 may sequentially compare first coordinate values, last coordinate values, intermediate coordinate values, and the other coordinate values of first vertex data (Vertex array(n)) and second vertex data (Vertex array(n+1)), thereby determining identity between the first frame and the second frame. The data processing apparatus 100 may apply the same method to the other data of the context data, such as the texture data, the render state, and the like.

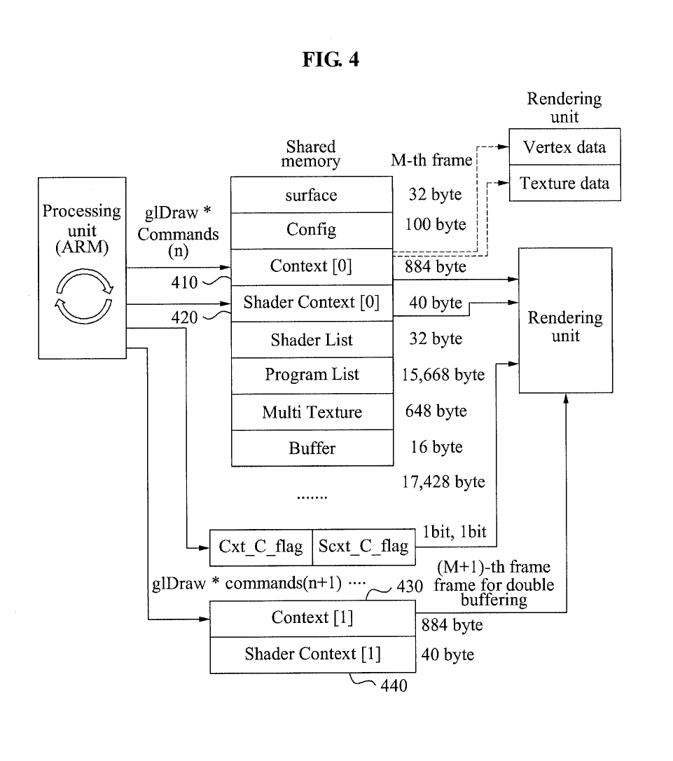

FIG. 4 illustrates a diagram showing that the frame is stored in the shared memory according to example embodiments.

Referring to FIG. 4, the processing unit 120 may store the input frame, that is, glDraw call(n), in the shared memory 130. Here, the processing unit 120 may be an Advanced RISC(Reduced Instruction Set Computer) Machine(ARM) processor of a CPU. The processing unit 120 may store, in the shared memory 130, the data related to the first frame(glDraw* command(n)), such as Surface, Config, Context[0], Shader Context[0], and the like. Here, the Context[0] may be first context data 410 and the Shader Context[0] may be first shader context data 420. The rendering unit 140 may extract the data related to the first frame from the shared memory 130, thereby generating the first rendering data. The rendering unit 140 as a 3D accelerator may use a Samsung Reconfigurable Processor (SRP).

The processing unit 120 may store whether the context data and the shader context data are changed by a 1 bit flag in the shared memory 130, and notify a core to take the stored data depending on whether the context data and the shader context data are changed.

In addition, the processing unit 120 may store, in the shared memory 130, the data related to the second frame (glDraw* command (n+1)), such as Surface, Config, Contex[1], Shader Context[1], and the like. Here, the Contex[1] may be second context data 430 and the Shader Context[1] may be second shader context data 440. Here, according to whether the first frame and the second frame are identical, the processing unit 120 may store, in the shared memory 130, address information related to the first context data 410 instead of the second context data 430, or address information related to the first shader context data instead of the second shader context data. The rendering unit 140 may generate the second rendering data by extracting the data related to the second frame stored in the shared memory 130.

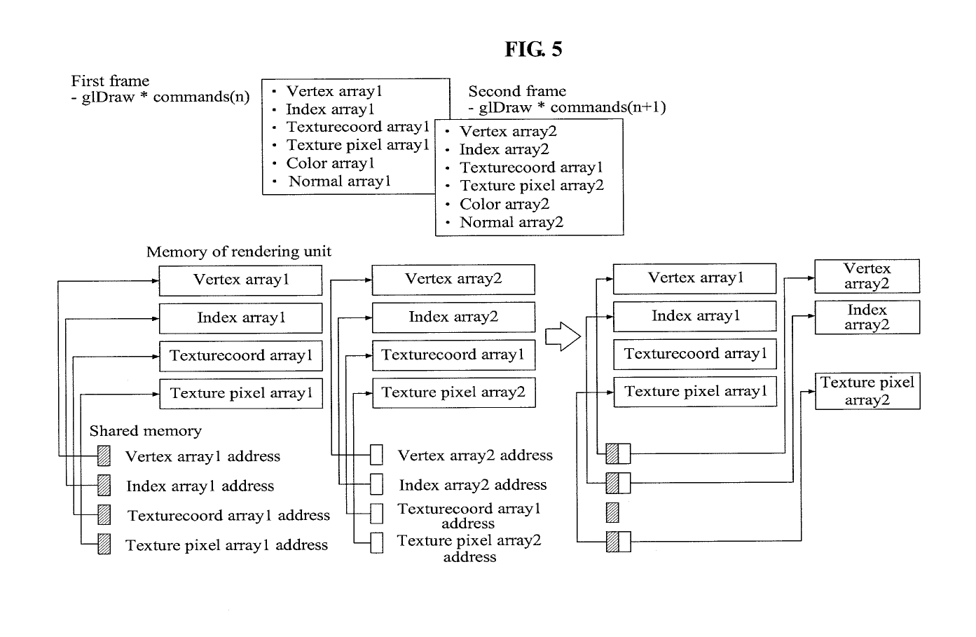

FIG. 5 illustrates a diagram showing a procedure of processing the context data according to example embodiments.

Referring to a right part of FIG. 5, the first context data contained in the first frame, that is, a context of the glDraw* command(n) is identical to part of the second context data contained in the second frame, that is, a context of the glDraw* command(n+1). According to a conventional art, although the first context data and the second context data have the same ‘Texturecoordinate array 1’, ‘Texturecoordinate array 2’ is stored in the shared memory 130 instead of reusing the ‘Texturecoordinate array 1.’

A left part of FIG. 5 shows the example embodiments. When the first context data and the second context data have the same ‘Texturecoordinate array 1’, the data processing apparatus 100 reuses ‘Texturecoordinate array 1’ instead of storing ‘Texturecoordinate array 2’ in the shared memory 130. Accordingly, the rendering unit 140 may reduce rendering time.

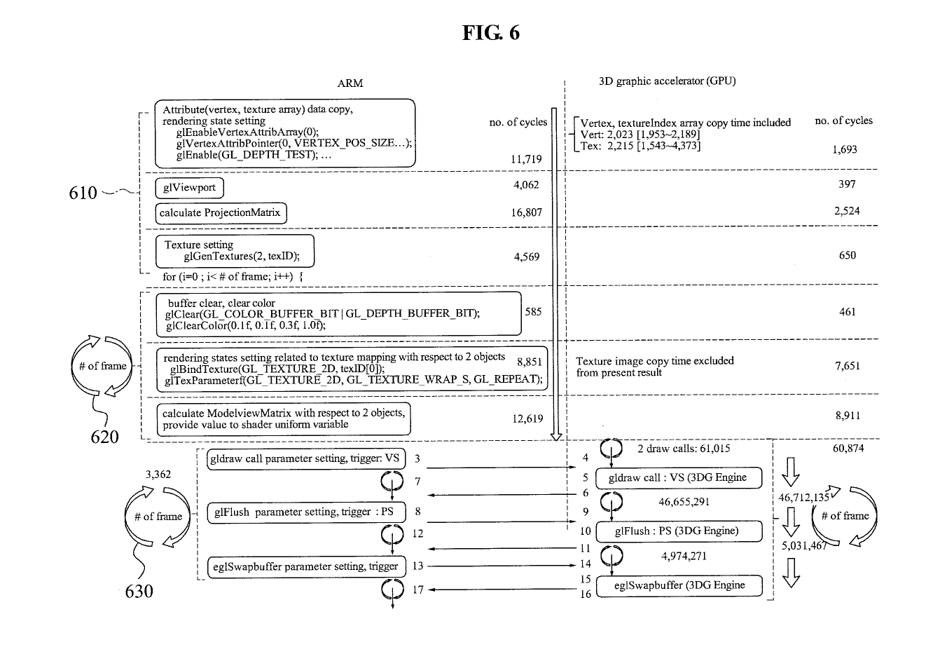

FIG. 6 illustrates a diagram showing that data processing time is reduced according to example embodiments.

Referring to FIG. 6, when the vertex data and the texture data are identical, time for processing the vertex data and the texture data by the 3D GPU may be reduced in operation 610.

In operation 620, when 2 glDraw* commands are called, the 3D GPU may reduce the rendering time.

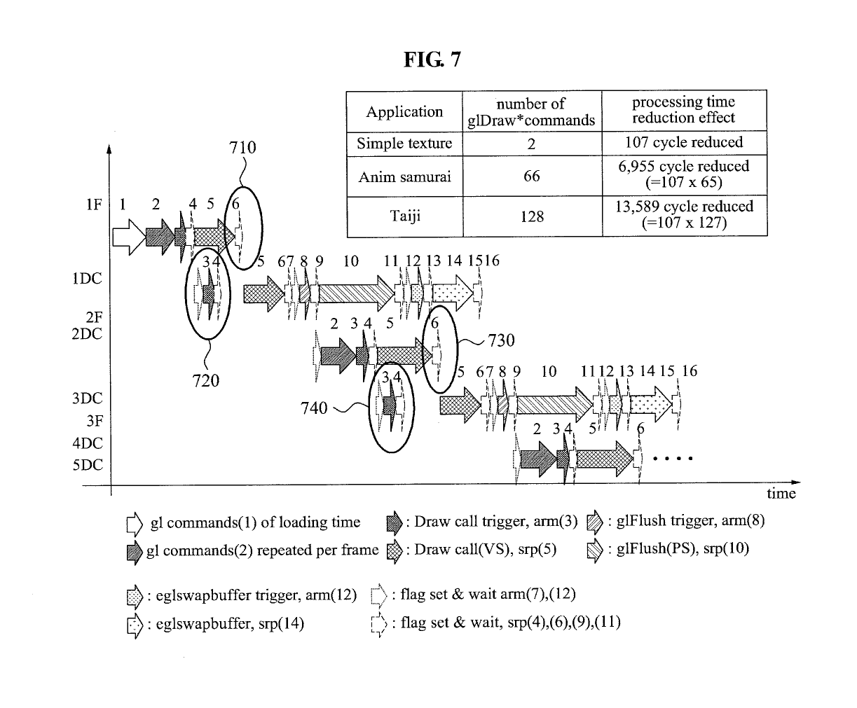

FIG. 7 illustrates a diagram showing that data processing time is reduced according to other example embodiments.

Referring to FIG. 7, the data processing apparatus 100 may reduce the data processing time in processing sections 710 through 740. For example, when 2 glDraw* commands are called in the data processing apparatus 100 that drives a ‘simple texture’ application, processing time corresponding to 107 cycles may be reduced. When 66 glDraw* commands are called in the data processing apparatus 100 that drives an ‘Anmi samurai’ application, processing time corresponding to 6,955 cycles may be reduced. In addition, when 128 glDraw* commands are called in the data processing apparatus 100 that drives a ‘Taiji’ application, processing time corresponding to 13,589 cycles may be reduced.

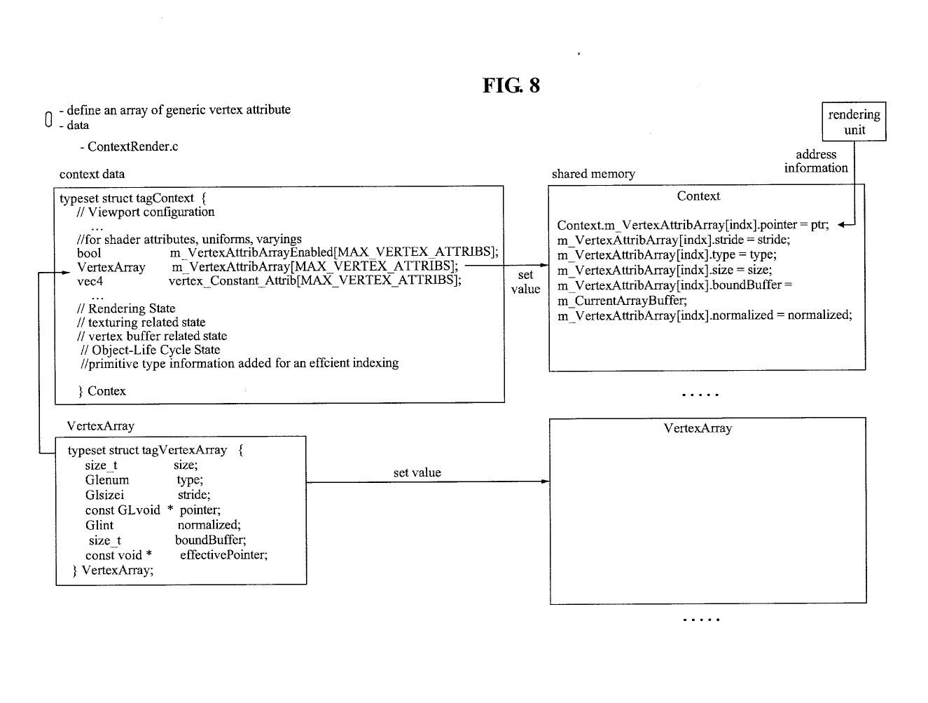

FIG. 8 illustrates a diagram showing a structure of data related to context data according to example embodiment.

Referring to FIG. 8, the data processing apparatus 100 compares values of the first context data contained in the first frame and the second context data contained in the second frame. The data processing apparatus 100 may store address information when the values are identical, and may store the second context data value in the shared memory 130 when the values are not identical. For example, when values of the second vertex data (Vertex array) of the first context data and of the second context data are identical, the data processing apparatus 100 may store address information containing the second vertex data value (Context.m_VertexAttribArray[indx].pointer=ptr) in the shared memory 130.

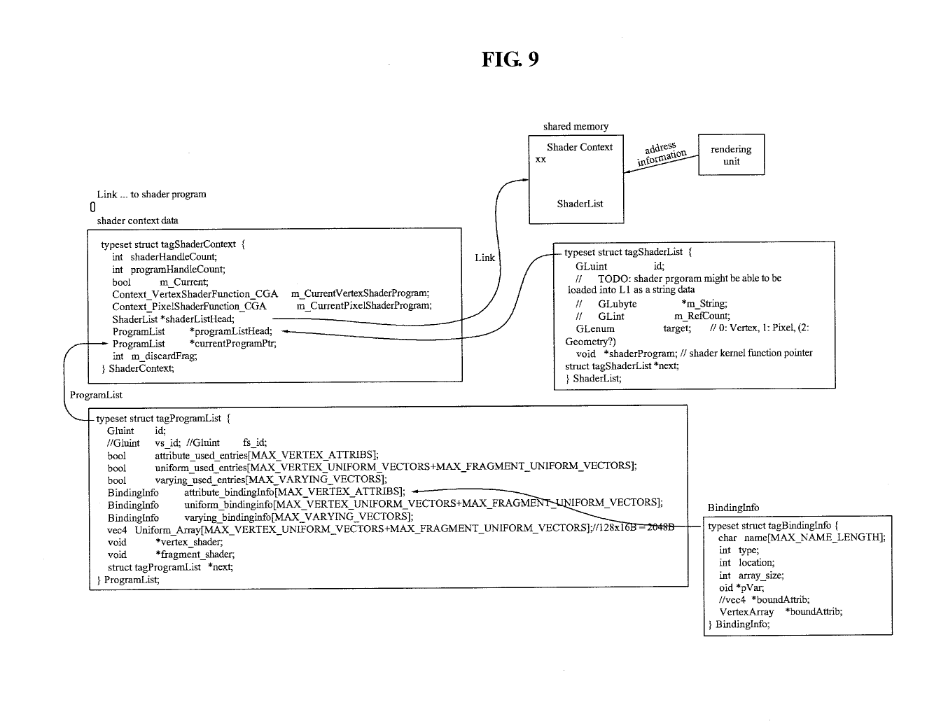

FIG. 9 illustrates a diagram showing a structure of data related to shader context data according to example embodiments.

Referring to FIG. 9, the data processing apparatus 100 compares values of the first shader context contained in the first frame and the second shader context data contained in the second frame. When the values are identical, the data processing apparatus 100 stores address information. When the values are not identical, the data processing apparatus 100 stores the second shader context data value in the shared memory 130. For example, when values of the second shader list (ShaderList) of the first shader context data and of the second shader context data are identical, the data processing apparatus 100 may store address information (xx) containing the second shader list value in the shared memory 130.

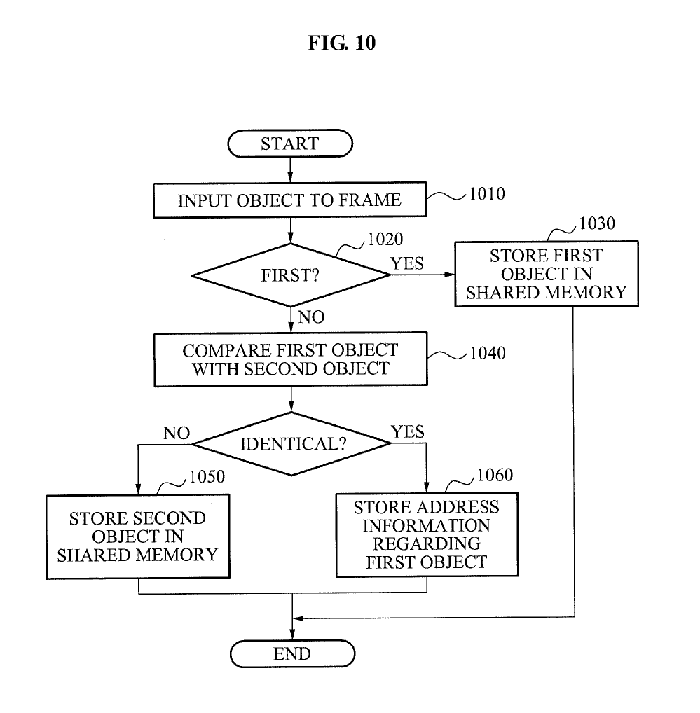

FIG. 10 illustrates a flowchart of a data processing method according to other example embodiments.

Referring to FIG. 10, in the data processing apparatus 100, an object is sequentially input in a frame, in operation 1010.

In operation 1020, the data processing apparatus 100 may determine whether the input object is a first-order object, that is, a first object. When the input object is the first object, the data processing apparatus 100 may store the first object in the shared memory in operation 1030. In other words, the data processing apparatus 100 may store data constituting the first object in the shared memory 130. In this case, it is interpreted that the first object is inputted in operation 1010.

When the input object is not the first object, the data processing apparatus 100 may compare the first object with a second object to determine whether the first object and the second object are identical, in operation 1040. In this case, it is interpreted that the second object is inputted in operation 1010.

When the first object and the second object are not identical, the data processing apparatus 100 may store the second object in the shared memory 130 in operation 1050. That is, the data processing apparatus 100 may store data related to the second object in the shared memory 130. In this case, the rendering unit 140 may generate rendering data related to the second object, using the data related to the second object.

When the first object and the second object are identical, the data processing apparatus 100 may store address information related to the first object in the shared memory 130 in operation 1060.

According to the example embodiments, when a previous frame and a current frame to be rendered are identical to each other, the previous frame is used for rendering instead of updating the current frame in a shared memory. Accordingly, the rendering time may be reduced.

When the previous frame and the current frame to be rendered are identical, only address information related to the previous frame is stored in the shared memory. Accordingly, a necessary storage space may be reduced.

When the previous frame and the current frame to be rendered are partially different, only different data may be stored in the shared memory, thereby reducing data to be updated.

In addition, whether a plurality of objects contained in one frame are updated is determined, and only updated objects are stored in the shared memory. Therefore, data to be updated may be reduced.

The data processing apparatus and/or controller may be embodied in the form of various kinds of packages. For example, the various kinds of packages may include Package on Package (PoP), Ball grid arrays(BGAs), Chip scale packages(CSPs), Plastic Leaded Chip Carrier(PLCC), Plastic Dual In-Line Package(PDIP), Die in Waffle Pack, Die in Wafer Form, Chip On Board(COB), Ceramic Dual In-Line Package(CERDIP), Plastic Metric Quad Flat Pack(MQFP), Thin Quad Flatpack(TQFP), Small Outline(SOIC), Shrink Small Outline Package(SSOP), Thin Small Outline(TSOP), Thin Quad Flatpack(TQFP), System In Package(SIP), Multi Chip Package(MCP), Wafer-level Fabricated Package(WFP), Wafer-Level Processed Stack Package(WSP), and the like.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on non-transitory computer-readable media comprising computer-readable recording media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

Further, according to an aspect of the embodiments, any combinations of the described features, functions and/or operations can be provided.

Although example embodiments have been shown and described, it would be appreciated by those skilled in the art that changes may be made in these example embodiments without departing from the principles and spirit of the disclosure, the scope of which is defined in the claims and their equivalents.

What is claimed is:

1. A data processing apparatus comprising:
an interface unit to be inputted with a second frame;
a processing unit to compare the second frame with a first frame having a time difference from the second frame and thereby determine whether the first frame and the second frame are identical; and
a shared memory to store address information related to the first frame when the first frame and the second frame are identical and to store the second frame when the first frame and the second frame are not identical.

2. The data processing apparatus of claim 1, wherein
the first frame and the second frame each comprise context data,
the processing unit stores, in the shared memory, address information related to first context data included in the first frame when the first context data and second context data included in the second frame are identical, and
the processing unit stores, in the shared memory, the second context data when the first context data included in the first frame and the second context data included in the second frame are not identical.

3. The data processing apparatus of claim 2, wherein
the first context data and the second context data each comprise at least one selected from attribute data, texture data, and a render state, and
when the processing unit determines that part of the second context data is identical to the first context data, the shared memory stores at least one of second attribute data, second texture data, and a second render state, which is different from the first context data, and stores address information related to at least one of first attribute data, first texture data, and a first render state, which is identical to the second context data.

4. The data processing apparatus of claim 1, further comprising:
a rendering unit to generate first rendering data using the first frame stored in the shared memory, and to generate second rendering data using the address information related to the first frame or using the second frame stored in the shared memory.

5. The data processing apparatus of claim 1, wherein
the first frame and the second frame each comprise shader context data,
the processing unit stores, in the shared memory, address information related to a first shader context data included in the first frame when the first shader context data and a second shader context data included in the second frame are identical, and
the processing unit stores the second shader context data in the shared memory when the first shader context data included in the first frame and the second shader context data included in the second frame are not identical.

6. The data processing apparatus of claim 2, wherein
the identity between frames is determined by comparing vertex data values included in the context data.

7. The data processing apparatus of claim 1, wherein
the processing unit is an Advanced Reduced Instruction Set Computer (RISC) Machine of a CPU.

8. A data processing apparatus comprising:
an interface unit to be inputted with a first object in a frame;
a processing unit to compare the first object with a second object having an object identification (ID) different from the first object and thereby determine whether the first object and the second object are identical; and
a shared memory to store address information related to the first object when the first object and the second object are identical and to store the second object when the first object and the second object are not identical,
wherein objects having different object IDs are treated at a different time or at a same time.

9. The data processing apparatus of claim 8, wherein
the processing unit compares a first sub object related to the first object with a second sub object having an object ID different from the first sub object, and thereby determines whether the first sub object is identical to the second sub object, and
the shared memory stores address information related to the first sub object when the first sub object and the second sub object are identical, and stores the second sub object when the first sub object and the second sub object are not identical.

10. The data processing apparatus of claim 8, wherein
the first object and the second object each comprise context data,
the processing unit stores, in the shared memory, address information related to first context data included in the first object when the first context data and second context data included in the second object are identical, and
the processing data stores the second context data in the shared memory when the first context data included in the first object and the second context data included in the second object are not identical.

11. The data processing apparatus of claim 10, wherein
the first context data included in the first object and the second context data included in the second object each comprise at least one of attribute data, texture data, and a render state, and
when the processing unit determines that part of the second context data is identical to the first context data, the shared memory stores at least one of second attribute data, second texture data, and a second render state, which is different from the first context data, and stores address information related to at least one of first attribute data, first texture data, and a first render state, which is identical to the second context data.

12. The data processing apparatus of claim 8, wherein
the first object and the second object each comprise shader context data,
the processing unit stores, in the shared memory, address information related to first shader context data included in the first object when the first shader context data and second shader context data included in the second object are identical, and
the processing unit stores the second shader context data in the shared memory when the first shader context data included in the first object and the second shader context data included in the second object are not identical.

13. A data processing method comprising:
inputting a second frame;
determining whether the second frame is identical to a first frame having a time difference from the second frame; and
storing address information related to the first frame or storing the second frame in a shared memory according to the determination result.

14. The data processing method of claim 13, wherein the storing of the address information or the second frame comprises:
storing the address information related to the first frame in the shared memory when the first frame and the second frame are determined to be identical; or
storing the second frame in the shared memory when the first frame and the second frame are not identical.

15. The data processing method of claim 13, wherein
the first frame and the second frame each comprise context data, and
the storing of the address information or the second frame comprises:
storing address information related to first context data included in the first frame when the first context data and second context data included in the second frame are identical; or
storing the second context data in the shared memory when the first context data included in the first frame and the second context data included in the second frame are not identical.

16. The data processing method of claim 15, wherein
the first context data and the second context data each comprise at least one of attribute data, texture data, and a render state, and
when part of the second context data is identical to the first context data according to the determination result, the storing of the address information or the second frame further comprises:
storing at least one of second attribute data, second texture data, and a second render state, which is different from the first context data, in the shared memory; and
storing address information related to at least one of first attribute data, first texture data, and a first render state, which is identical to the second context data, in the shared memory.

17. The data processing method of claim 13, further comprising:
generating second rendering data using the address information related to the first frame; or
generating second rendering using the second frame.

18. The data processing method of claim 13, wherein
the first frame and the second frame each comprise shader context data, and
the storing of the address information or the second frame comprises:
storing, in the shared memory, address information related to first shader context data included in the first frame when the first shader context data and second shader context data included in the second frame are identical; or
storing the second shader context data in the shared memory when the first shader context data included in the first frame and the second shader context data included in the second frame are not identical.

19. The data processing method of claim 15, wherein
the identity between frames is determined by comparing vertex data values included in the context data.

20. A data processing method comprising:
determining whether a first object included in a frame is identical to a second object having an object identification (ID) different from the first object, by comparing the first object with the second object; and
storing address information related to the first object or storing the second object in a shared memory according to the determination result,
wherein objects having different object IDs are treated at a different time or at a same time.

21. The data processing method of claim 20, wherein the storing of the address information or the second object comprises:
storing the address information related to the first object in the shared memory when the first object and the second object are identical; or
storing the second object in the shared memory when the first object and the second object are not identical.

22. The data processing method of claim 20, further comprising:
comparing a first sub object related to the first object with a second sub object having a sub object ID different from the first sub object to determine whether the first sub object and the second sub object are identical; and
storing address information related to the first sub object when the first sub object and the second sub object are identical, or storing the second sub object when the first sub object and the second sub object are not identical according to the determination result,
wherein objects having different object IDs are treated at a different time or at a same time.

23. The data processing method of claim 20, wherein
the first object and the second object each comprise context data, and
the storing of the address information or the second object comprises:
storing, in the shared memory, address information related to first context data included in the first object when the first context data is identical to second context data included in the second object; or
storing the second context data in the shared memory when the first context data included in the first object and the second context data included in the second object are not identical.

24. The data processing method of claim 24, wherein
the first object and the second object each comprise shader context data, and
the storing of the address information or the second frame comprises:
storing, in the shared memory, address information related to first shader context data included in the first object when the first shader context data and second shader context data included in the second object are identical; or
storing the second shader context data in the shared memory when the first shader context data included in the first object and the second shader context data included in the second object are not identical.

25. The data processing method of claim 24, wherein
the identity between frames is determined by comparing vertex data values included in the context data.

26. A system to process data, comprising:
an interface unit to receive a first frame and a second frame,
wherein the first frame and the second frame are temporally different from each other;
a processing unit to determine whether the first frame and the second frame are identical; and
a shared memory to store address information related to the first frame when the first frame and the second frame are identical, and to store the second frame when the first frame and the second frame are not identical.

27. The system of claim 26, wherein
the first frame and the second frame each comprise context data,
the processing unit stores, in the shared memory, address information related to first context data included in the first frame when the first context data and second context data included in the second frame are identical, and
the processing unit stores, in the shared memory, the second context data when the first context data included in the first frame and the second context data included in the second frame are not identical.

28. The system of claim 27, wherein
the first context data and the second context data each comprise at least one selected from attribute data, texture data, and a render state, and
when the processing unit determines a portion of the second context data to be identical to the first context data, the shared memory stores address information related to at least one of first attribute data, first texture data, and a first render state, corresponding to the portion of the second context data that is identical to the first context data, and stores at least one of second attribute data, second texture data, and a second render state, corresponding to a portion of the second context data that is not identical to the first context data.
